(19) United States
(12) Patent Application Publication
(10) Pub. No.: US 2002/0044680 A1
(43) Pub. Date: Apr. 18, 2002

(54) Method of extracting epipolar curve of stereoscopic image photographed by linear pushbroom (LPB) sensor

(76) Inventors: Tae Jung Kim, Taejon (KR); Heung Kyu Lee, Taejon (KR)

Correspondence Address: BACON & THOMAS, PLLC, 625 Slaters Lane - 4th Floor, Alexandria, VA, 22314-1176, US

(21) Appl. No.: 09/785,291

(22) Filed: Feb. 20, 2001

(30) Foreign Application Priority Data
Aug. 21, 2000 (KR) 10-2000-48429

(51) Int. Cl. G06K 9/00

(52) U.S. Cl. 382/154

(57) ABSTRACT

Disclosed is a method of extracting an epipolar curve C′_{q} of the right image (or an epipolar curve C_{q′} of the left image) corresponding to one point q of the left image (or one point q′ of the right image) in a stereoscopic image photographed by a linear pushbroom (LPB) sensor, comprising the steps of: assuming that the coordinates for the positions of the left and right cameras and the coordinates of the rotating angles of the left and right cameras are linear or nonlinear polynomials for a time or an image coordinate, and then deriving collinear equations consisting of various Expressions; calculating the coordinate value of a straight line Sq for connecting a focal point S of the left image and the one point q of the left image; substituting the calculated coordinate value of the straight line Sq into the collinear equation of the one point q′ of the right image; and combining the Expressions of the substituted collinear equation, and deriving an equation of the epipolar curve C′q of the right image for the one point q of the left image.

### BACKGROUND OF THE INVENTION

1. Field of the Invention

The present invention relates to a method of extracting an epipolar curve of a stereoscopic image photographed by a linear pushbroom (LPB) sensor, and more particularly, a technology which proposes a method of extracting an epipolar curve of a stereoscopic image photographed by a linear pushbroom (LPB) sensor, to which a method for a general perspective sensor cannot be applied, to enable both a creation of a precise three-dimensional (3D) topography information and a processing of the stereoscopic images.

2. Description of the Related Art

The linear pushbroom (LPB) sensor used herein refers to a sensor which is capable of obtaining an image through a photographing method or scanning method in which when an object is photographed, a focal point is moved successively, so a separate focal point exists by each line or part within an image of the object. The perspective sensor used herein refers to a sensor which has a single fixed focal point per an image of an object.

The stereoscopic image used herein refers to more than two images that photograph the same region of a topography at different angles and different positions.

The epipolar curve used herein refers to a locus on the right image (or the left image) representing all possible positions that a point of the left (or the right) image is corresponding to, assuming that the stereoscopic image consists of the two images without departing from the scope of a generality and naming the two images as the left and right image, respectively.

FIG. 1 is a diagrammatic view illustrating an epipolar curve of a stereoscopic image photographed by a perspective sensor according to the prior art.

The epipolar curve of the stereoscopic image will now be described hereinafter with reference to FIG. 1.

First, a focal point of the left image is defined as S, one point of the left image is defined as q, and the line connecting the focal point S of the left image and the one point q of the left image is defined as a straight line Sq with respect to a ground reference (control) coordinate system.

The point on the earth surface or the surface of a photographed region corresponding to the one point q of the left image is defined as a ground point Q, and the position of the ground point Q always exists on an extension line of the straight line Sq. One point q′ of the right image corresponding to the ground point Q is called a conjugate point of q, and the one point q′ of the right image is the intersection between a straight line defined to pass through the focal point S′ of the right image from one point on the extension line of the straight line Sq and the surface of the right image.

At this time, a set of intersection points between the surface of the right image and straight lines connecting the focal point S′ of the right image and all the points on the extension line of the straight line Sq is represented in the form of a curved line, and this curved line is called an epipolalr curve of the right image corresponding to the one point q of the left image.

That is, the one point q′ corresponding to the counterpart of the one point q of the left image always exists on the epipolar curve. An epipolalr curve of the left image corresponding to the one point q′ of the right image can also be defined vice versa based on such explanation on the epipolar curve of the right image corresponding to the one point q of the left image.

As described above, in case of the stereoscopic image photographed by a perspective sensor, the epipolar curve of the stereoscopic image is represented in the form of a straight line, and a technology for extracting this epipolar curve has already been developed and is widely used.

However, despite the epipolar curve of the stereoscopic image photographed by the perspective sensor has a main characteristic of the stereoscopic image and is included in almost all photogrammetry textbooks, there have not been disclosed a method of extracting the epipolar curve of the stereoscopic image from the linear pushbroom (LPB) sensor, having a characteristic that when an object is photographed, a focal point is moved successively and a separate focal point exists by each line or part within an image of the object.

In addition, although a method of extracting the epipolar curve of the stereoscopic image photographed by the linear pushbroom (LPB) sensor is not identical with a method of extracting the epipolar curve of the stereoscopic image photographed by a perspective sensor, the two methods are wrongly considered to be identical and the latter are mis-used for the former, thereby resulting in a generation of an error.

### SUMMARY OF THE INVENTION

Therefore, the present invention has been made in view of the above-mentioned problems, and it is an object of the present invention to provide a method of correctly extracting an epipolar curve of the right image (or left image) corresponding to one point of the left image (or the right image) in a stereoscopic image photographed by a linear pushbroom (LPB) sensor.

According to the present invention, there is provided a method of correctly extracting an epipolar curve C′_{q} of the right image (or an epipolar curve C_{q′} of the left image) corresponding to one point q of the left image (or one point q′ of the right image) in a stereoscopic image photographed by a linear pushbroom (LPB) sensor, comprising the steps of:

assuming that the coordinates for the positions of the left and right cameras and the coordinates of the rotation angles of the left and right cameras are linear or nonlinear polynomials of a time or an image coordinate, and then deriving collinear equations consisting of various Expressions;

calculating the coordinate value of a straight line Sq for connecting a focal point S of the left image and the one point q of the left image;

substituting the calculated coordinate value of the straight line Sq into the collinear equation of the one point q′ of the right image; and

combining the Expressions of the substituted collinear equation, and deriving an equation of the epipolar curve C′q of the right image for the one point q of the left image.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a diagrammatic view illustrating an epipolar curve of a stereoscopic image photographed by a perspective sensor according to the prior art;

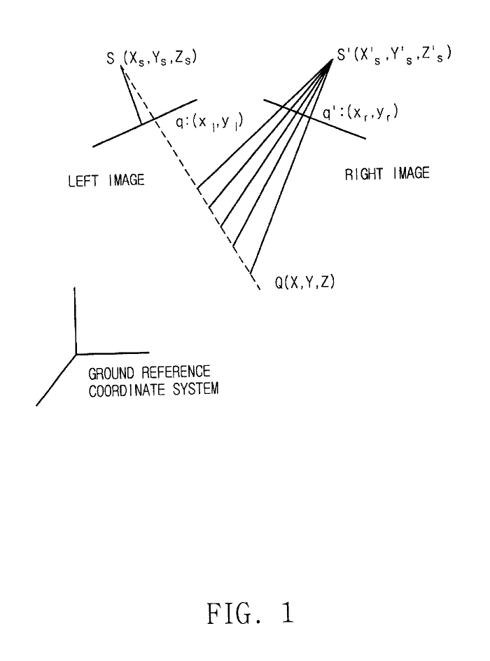

FIG. 2 is a flowchart illustrating the process for extracting an epipolar curve of a stereoscopic image photographed by a linear pushbroom (LPB) sensor according to a preferred embodiment of the present invention; and

FIG. 3 is a graph illustrating a distribution of an epipolar curve of a stereoscopic image photographed by a linear pushbroom (LPB) sensor according to a preferred embodiment of the present invention.

### DETAILED DESCRIPTION OF THE PREFERRED EMBODIMENT

Reference will now be made in detail to the preferred embodiments of the present invention.

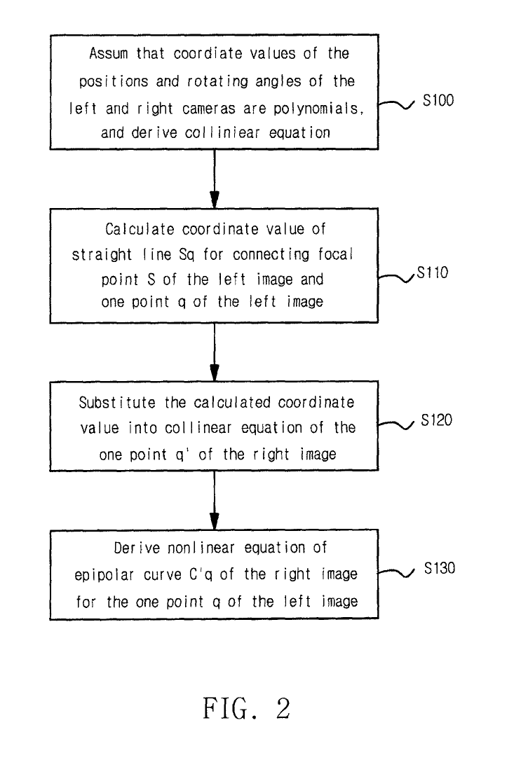

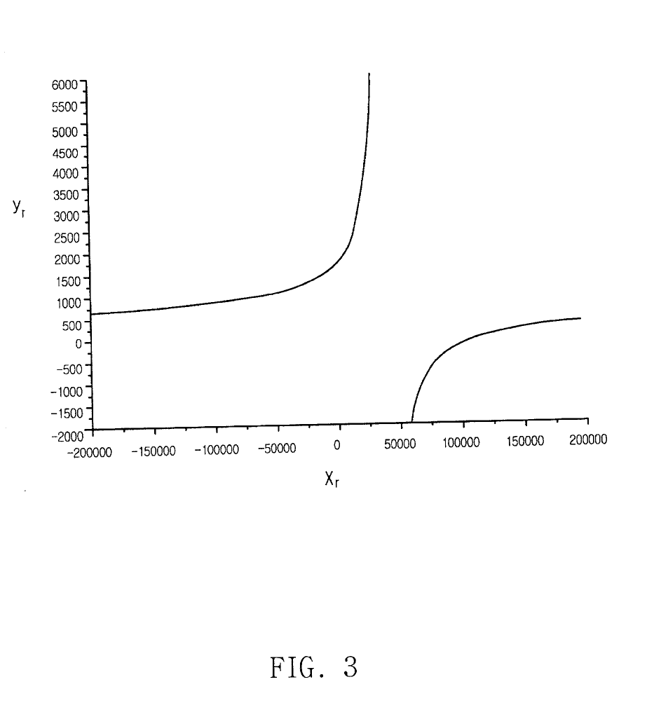

FIG. 2 is a flowchart illustrating the process for extracting an epipolar curve of a stereoscopic image photographed by a linear pushbroom (LPB) sensor according to a preferred embodiment of the present invention, and FIG. 3 is a graph illustrating a distribution of an epipolar curve of a stereoscopic image photographed by a linear pushbroom (LPB) sensor according to a preferred embodiment of the present invention.

Referring to FIGS. 2 and 3, first, an extraction of the epipolar curve of the stereoscopic image photographed by the linear pushbroom (LPB) sensor requires a sensor model representating of the relationship between a camera used at the time when the camera photographed each image and the earth reference coordinate system. Such a sensor model can be expressed by using the following collinear equation.

Of course, the collinear equation for the linear pushbroom sensor (LPB) may be written a little differently from the following Expressions according to circumstances, but it should be noted that the present invention is not limited to the collinear equation written by a specific Expression.

$${x}_{l} = 0 = - f \frac{{r}_{11} ( X - {X}_{s} ) + {r}_{21} ( Y - {Y}_{s} ) + {r}_{31} ( Z - {Z}_{s} )}{{r}_{13} ( X - {X}_{s} ) + {r}_{23} ( Y - {Y}_{s} ) + {r}_{33} ( Z - {Z}_{s} )} \qquad [ Expression 1 ]$$

$${y}_{l} = - f \frac{{r}_{12} ( X - {X}_{s} ) + {r}_{22} ( Y - {Y}_{s} ) + {r}_{32} ( Z - {Z}_{s} )}{{r}_{13} ( X - {X}_{s} ) + {r}_{23} ( Y - {Y}_{s} ) + {r}_{33} ( Z - {Z}_{s} )} \qquad [ Expression 2 ]$$

$${x}_{r} = 0 = - f \frac{{r}_{11}^{′} ( X - {X}_{s}^{′} ) + {r}_{21}^{′} ( Y - {Y}_{s}^{′} ) + {r}_{31}^{′} ( Z - {Z}_{s}^{′} )}{{r}_{13}^{′} ( X - {X}_{s}^{′} ) + {r}_{23} ( Y - {Y}_{s}^{′} ) + {r}_{33}^{′} ( Z - {Z}_{s}^{′} )} \qquad [ Expression 3 ]$$

$${y}_{r} = - {f}^{′} \frac{{r}_{12}^{′} ( X - {X}_{s}^{′} ) + {r}_{22}^{′} ( Y - {Y}_{s}^{′} ) + {r}_{32}^{′} ( Z - {Z}_{s}^{′} )}{{r}_{13}^{′} ( X - {X}_{s}^{′} ) + {r}_{23}^{′} ( Y - {Y}_{s}^{′} ) + {r}_{33}^{′} ( Z - {Z}_{s}^{′} )} \qquad [ Expression 4 ]$$

A coordinate (xₗ,yₗ) in the above [Expression 1] and [Expression 2] denotes a coordinate of one point q of the left image, and a coordinate (xᵣ,yᵣ) in the [Expression 3] and [Expression 4] denotes a coordinate of one point q′ of the right image.

In the linear pushbroom (LPB) sensor of the present invention, a separate focal point exists by each line or part within an image of an object and a resultant image coordinate system is defined accordingly. Hence, the coordinate values of xₗ and xᵣ in the [Expression 1] and [Expression 3] are set to 0, respectively.

In the Expressions, (X,Y,Z) denotes a coordinate of the ground point Q on a ground reference coordinate system, and (Xₛ,Yₛ,Zₛ) and (X′ₛ,Y′ₛ,Z′ₛ) denote coordinates of focal points S and S′ of the left image and a focal point S′ of the right image on the ground reference coordinate system, respectively.

Also, f denotes a focal length of the linear pushbroom (LPB) sensor which has photographed the left image, and f′ denotes a focal length of the linear pushbroom (LPB) sensor which has photographed the right image.

r₁₁˜r₃₃ denotes coefficients of a rotational transformation matrix for making a coordinate system of the left image coincident with the ground reference coordinate system, and can be expressed by means of rotating angles kₗ,Φₗ,ωₗ at which a camera rotates about X, Y and Z axes as the [Expression 5]:

[Expression 5]

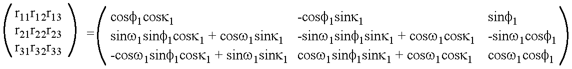

It can be seen from [Expression 5], that r′₁₁˜r′₃₃ in the [Expression 3] and [Expression 4] denotes coefficients of a rotational transformation matrix for making a coordinate system of the right image coincident with the ground reference coordinate system, and can be expressed similarly to the [Expression 5] through the use of the rotating angles kᵣ,Φᵣ,ωᵣ.

That is, in the linear pushbroom (LPB) sensor unlike a conventional perspective sensor, since a separate focal point exists by each line or part within an image of an object and a posture of the camera may be varied by each line or part, (Xₛ,Yₛ,Zₛ) and (X′ₛ,Y′ₛ,X′ₛ) in the [Expression 1] through [Expression 4] can be expressed in a linear or nonlinear polynomial for xₗ and xᵣ according to the photographing method or scanning method.

In addition, the rotating angles kₗ,Φₗ,ωₗ at which a camera rotates about X, Y and Z axes to make the coordinate system of the left image coincident with the ground reference coordinate system and the rotating angles kᵣ,Φᵣ,ωᵣ at which a camera rotates about X, Y and Z axes to make the coordinate system of the right image coincident with the ground reference coordinate system can also be expressed by the linear or nonlinear polynomial for xₗ and xᵣ, respectively.

The epipolar curve of the stereoscopic image photographed by the linear pushbroom (LPB) sensor can be extracted by the following Expression on the basis of the above-mentioned collinear equation.

Next, the process for extracting the epipolar curve of the stereoscopic image photographed by the linear pushbroom (LPB) sensor will be described in detail hereinafter with reference to FIG. 2.

First, at step S100, after assuming that the coordinate (Xₛ,Yₛ,Zₛ) for a position of the left camera, the coordinate (X′ₛ,Y′ₛ,Z′ₛ) for a position of the right camera, the coordinate of the rotating angle kₗ,Φₗ,ωₗ of the left camera, and the coordinate of the rotating angle kᵣ,Φᵣ,ωᵣ of the right camera are the linear or nonlinear polynomials for xₗ and xᵣ, respectively, they are substituted into the collinear equation written in [Expression 1] through [Expression 4].

At subsequent step S110, a straight line Sq for connecting a focal point S of the left image and one point q of the left image is calculated by [Expression 6] using a parameter k.

[Expression 6]

(X,Y,Z)=(Xₛ,Yₛ,Zₛ)+k(x′₁,y′₁,z′₁)

Here, (x′ₗ,y′ₗ,z′ₗ) can be expressed by the following [Expression 7].

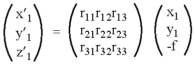

Subsequently, at step S120, the coordinate value of the straight line Sq obtained by [Expression 6] is substituted into the collinear equation derived from the step S100. At step S130, the Expressions of the substituted collinear equation are combined, and a resultant epipolar curve C′q of the right image for the one point q(x₁,y₁) of the left image can be expressed by a nonlinear equation of the following [Expression 8].

$${y}_{r} = \frac{{A}_{1} {x}_{l} + {A}_{2} {y}_{l} + {A}_{3}}{\begin{matrix}( {A}_{4} {x}_{l} + {A}_{5} {y}_{l} {A}_{6} ) sin Q ( {x}_{r} ) + \\ ( {A}_{7} {x}_{l} + {A}_{8} {y}_{l} + {A}_{9} ) cos Q ( {x}_{r} )\end{matrix}} \qquad [ Expression 8 ]$$

A1˜A9 in the [Expression 8] denotes constants determined by a given coordinate value (xₗ,yₗ) of the one point q of the left image, and Q(xᵣ) denotes a linear or nonlinear equation of the coordinate xᵣ for the one point q′ of the right image.

In the case where the epipolar curve according to the present invention is drawn actually on the basis of the [Expression 8], the epipolar curve appears in the form of a hyperbola as shown in FIG. 3.

That is, as shown in FIG. 3, the epipolar curve of the linear pushbroom (LPB) sensor appears in the form nearly close to a hyperbola but not a straight line.

As described above, the typical features of the epipolar curve of the linear pushbroom (LPB) sensor according to the present invention are as follow:

1) The epipolar curve of the linear pushbroom (LPB) sensor appears in the form of a curved line but not a straight line.

2) The epipolar curve of the linear pushbroom (LPB) sensor can be assumed to be a straight line in a small region within a stereoscopic image photographed by the linear pushbroom (LPB) sensor.

3) If it is assumed that an epipolar curve C′_{q} of the right image is obtained from one point q of the left image of a stereoscopic image photographed by linear pushbroom (LPB) sensor and an epipolar curve C_{q′} of the left image is obtained from one point q′ of the right image corresponding to the one point q of the left image, in the case of a stereoscopic image photographed by the linear pushbroom sensor all the points on the epipolar curve C′_{q} are not mapped onto the epipolar curve C_{q′} and all the points on the epipolar curve C_{q′} are not mapped onto the epipolar curve C′_{q} unlike the case of a stereoscopic image photographed by a perspective sensor.

4) In the case of obtaining C′_{q} and C_{q′} in the feature 3), it can be assumed that points on the epipolar curve C′_{q} are mapped onto the epipolar curve C_{q′} and points on the epipolar curve C_{q′} are mapped onto the epipolar curve C′_{q} only for both a small region near the one point q of the left image and a small region near the one point q′ of the right image.

As can be seen from the foregoing, a method of extracting an epipolar curve of a stereoscopic image photographed by a linear pushbroom (LPB) sensor according to present invention has the following advantages.

First, since a method of extracting epipolar curve of a stereoscopic image photographed by a conventional perspective sensor is different from the method of extracting epipolar curve of the stereoscopic image photographed by the linear pushbroom (LPB) sensor, it is clear that the conventional epipolar curve extracting method for a perspective sensor cannot be applied to the linear pushbroom (LPB) sensor of the present invention.

Second, the epipolar curve of the stereoscopic image taken from the linear pushbroom (LPB) sensor can be extracted by a collinear equation of the epipolar curve proposed in the present invention.

Third, it is clear that all the methods associated with extraction of the epipolar curve applicable for processing a stereoscopic image photographed by a conventional perspective sensor cannot be applied to the stereoscopic image photographed by the linear pushbroom (LPB) sensor.

Fourth, since the epipolar curve of the stereoscopic image photographed by the linear pushbroom (LPB) sensor can be expressed in a precise Expression, a processing of the stereoscopic image of the linear pushbroom (LPB) sensor is possible.

While this invention has been described in connection with what is presently considered to be the most practical and preferred embodiment, it is to be understood that the invention is not limited to the disclosed embodiment, but, on the contrary, it is intended to cover various modifications within the spirit and scope of the appended claims.

What is claimed is:

1. A method of extracting an epipolar curve C′_{q} of the right image (or an epipolar curve C_{q′} of the left image) corresponding to one point q of the left image (or one point q′ of the right image) in a stereoscopic image photographed by a linear pushbroom (LPB) sensor, comprising the steps of:
assuming that the coordinates for the positions of the left and right cameras and the coordinates of the rotation angles of the left and right cameras are linear or nonlinear polynomials of a time or an image coordinate, and then deriving collinear equations consisting of various Expressions;
calculating the coordinate value of a straight line Sq for connecting a focal point S of the left image and the one point q of the left image;
substituting the calculated coordinate value of the straight line Sq into the collinear equation of the one point q′ of the right image; and
combining the Expressions of the substituted collinear equation, and deriving an equation of the epipolar curve C′q of the right image for the one point q of the left image.

2. The method according to claim 1, wherein the derived equation of the epipolar curve C′q of the right image for the one point q of the left image has the following Expression.
$${y}_{r} = \frac{{A}_{1} {x}_{l} + {A}_{2} {y}_{l} + {A}_{3}}{( {A}_{4} {x}_{l} + {A}_{5} {y}_{l} {A}_{6} ) sin Q ( {x}_{r} ) + ( {A}_{7} {x}_{l} + {A}_{g} {y}_{l} + {A}_{9} ) cos Q ( {x}_{r} )}$$
Here, A1˜A9 denotes constants determined by a given coordinate value (xₗ,yₗ) of the one point q of the left image, and Q(xᵣ) denotes a linear or nonlinear equation of the coordinate xᵣ for the one point q′ of the right image.

3. The method according to claim 1, wherein the epipolar curve of the linear pushbroom (LPB) sensor has the form of a curved line but not a straight line.

4. The method according to claim 1, wherein the epipolar curve of the linear pushbroom (LPB) sensor having the form of the curved line is assumed to be a straight line in a small region within the stereoscopic image photographed by the linear pushbroom (LPB) sensor.

5. The method according to claim 1, wherein if it is assumed that the epipolar curve C′_{q} of the right image is obtained from the one point q of the left image of the stereoscopic image photographed by linear pushbroom (LPB) sensor and the epipolar curve C_{q′} of the left image is obtained from the one point q′ of the right image corresponding to the one point q of the left image, in the case of the stereoscopic image photographed by the linear pushbroom sensor all the points on the epipolar curve C′_{q} are not mapped onto the epipolar curve C_{q′} and all the points on the epipolar curve C_{q′} are not mapped onto the epipolar curve C′_{q}.

6. The method according to claim 5, wherein in the case where C′_{q} and C_{q′} have been obtained, it is assumed that points on the epipolar curve C′_{q} are mapped onto the epipolar curve C_{q′} and points on the epipolar curve C_{q′} are mapped onto the epipolar curve C′_{q} only for both a small region near the one point q of the left image and a small region near the one point q′ of the right image.
